(19) United States
(12) Patent Application Publication
(10) Pub. No.: US 2013/0171898 A1
(43) Pub. Date: Jul. 4, 2013

(54) VIBRATION-DAMPING SHEET AND METHOD FOR DAMPING VIBRATION

(71) Applicant: Yasuhiko Kawaguchi, Osaka (JP)

(72) Inventor: Yasuhiko Kawaguchi, Osaka (JP)

(73) Assignee: NITTO DENKO CORPORATION, Osaka (JP)

(21) Appl. No.: 13/820,881

(22) PCT Filed: Aug. 22, 2011
(86) PCT No.: PCT/JP2011/068864

§ 371 Date: Mar. 5, 2013

(30) Foreign Application Priority Data
Sep. 6, 2010 (JP) 2010-199034

(51) Int. Cl. F16F 15/02; B32B 17/04

(52) U.S. Cl. CPC F16F 15/02; B32B 17/04
USPC 442/120; 428/356; 156/60

(57) ABSTRACT

A vibration-damping sheet to be bonded to a metal adherend includes a resin layer and a constraining layer laminated on the resin layer. The resin layer contains a pressure-sensitive adhesive resin, a metal which has a higher ionization tendency than that of the metal adherend, and an electrically-conductive carbon.

### TECHNICAL FIELD

The present invention relates to a vibration-damping sheet and a method for damping vibration, to be specific, to a vibration-damping sheet used by being bonded to a steel plate or the like of various industrial products and a method for damping vibration in which vibration damping of the steel plate or the like is achieved using the vibration-damping sheet.

### BACKGROUND ART

Conventionally, an automobile steel plate is generally processed into a thin plate of 0.6 to 0.8 mm so as to reduce the weight of a vehicle body. Therefore, a vibration sound is easily generated at the time of driving of an automobile and a noise is generated at the time of opening or closing the vehicle door. It has been known that a vibration-damping reinforcement sheet is bonded to the automobile steel plate in order to prevent the generation of the vibration sound and the noise.

As such a vibration-damping reinforcement sheet, for example, a vibration-damping reinforcement sheet which includes a vibration-damping reinforcement layer containing a butyl rubber, an acrylonitrile-butadiene rubber, an epoxy resin, and an epoxy resin curing agent and a constraining layer laminated on one surface of the vibration-damping reinforcement layer has been proposed (ref: for example, the following Patent Document 1).

### PRIOR ART DOCUMENT

### Patent Document

Patent Document 1: Japanese Unexamined Patent Publication No. 2009-161659

### SUMMARY OF THE INVENTION

### Problems to be Solved by the Invention

However, the steel plate is subjected to an electrodeposition coating after the vibration-damping reinforcement sheet is bonded thereto. Therefore, a portion of the steel plate to which the vibration-damping reinforcement sheet is bonded is not subjected to a coating and as a result, there is a disadvantage that when water or oxygen infiltrates a bonded portion of the vibration-damping reinforcement sheet in the steel plate, the steel plate is oxidized and corrosion such as rust occurs.

It is an object of the present invention to provide a vibration-damping sheet which is capable of reducing the oxidation of a bonded portion of the vibration-damping sheet in a metal adherend over a long period of time and a method for damping vibration in which the vibration-damping sheet is used.

### Solution to the Problems

A vibration-damping sheet to be bonded to a metal adherend of the present invention includes a resin layer and a constraining layer laminated on the resin layer, wherein the resin layer contains a pressure-sensitive adhesive resin, a metal which has a higher ionization tendency than that of the metal adherend, and an electrically-conductive carbon.

In the vibration-damping sheet of the present invention, it is preferable that the volume resistivity of the resin layer is 1×10⁸Ω cm or less.

In the vibration-damping sheet of the present invention, it is preferable that the metal is zinc.

In the vibration-damping sheet of the present invention, it is preferable that the glass transition temperature (Tg) of the resin layer is −40° C. or more and 20° C. or less.

In the vibration-damping sheet of the present invention, it is preferable that the constraining layer is made of a glass cloth.

A method for damping vibration of the present invention includes bonding the above-described vibration-damping sheet to a metal adherend.

A method for damping vibration of the present invention includes bonding the above-described vibration-damping sheet in which a metal is zinc to a steel plate or a zinc-plated steel plate.

### Effect of the Invention

When the vibration-damping sheet of the present invention is bonded to the metal adherend, the generation of the vibration sound and the noise can be effectively reduced.

In the vibration-damping sheet of the present invention, the metal which has a higher ionization tendency than that of the metal adherend and the electrically-conductive carbon are contained in the resin layer. Therefore, in the bonded portion of the vibration-damping sheet in the metal adherend, the metal adherend is not easily oxidized while the metal contained in the resin layer is oxidized due to the function of a local cell. Accordingly, vibration damping of the metal adherend can be achieved and the oxidation of the metal adherend is reduced, so that the occurrence of corrosion such as rust can be reduced.

### BRIEF DESCRIPTION OF THE DRAWINGS

FIG. 1 shows process drawings for illustrating one embodiment of a method for vibration damping of a steel plate as a metal adherend using a vibration-damping sheet of the present invention:

(a) illustrating a step of preparing the vibration-damping sheet and peeling off a releasing paper and

(b) illustrating a step of bonding the vibration-damping sheet to the steel plate.

### EMBODIMENT OF THE INVENTION

A vibration-damping sheet of the present invention is to be bonded to a metal adherend and includes a resin layer and a constraining layer laminated on the resin layer.

In the present invention, the resin layer, which allows close contact and integration with the constraining layer and reduces the generation of a vibration sound or the like of the metal adherend, is formed from a pressure-sensitive adhesive composition into a sheet shape.

The pressure-sensitive adhesive composition contains at least a pressure-sensitive adhesive resin, a metal which has a higher ionization tendency than that of the metal adherend, and an electrically-conductive carbon.

The pressure-sensitive adhesive resin is not particularly limited and examples thereof include a butyl rubber, a natural rubber, an isoprene rubber, a butadiene rubber, a styrene-butadiene rubber, and a nitrile-butadiene rubber.

These pressure-sensitive adhesive resins can be used alone or in combination.

Of the pressure-sensitive adhesive resins, in view of adhesive characteristics and vibration-damping characteristics, preferably, a butyl rubber is used.

The butyl rubber is a synthetic rubber obtained by copolymerization of isobutene (isobutylene) and isoprene.

The butyl rubber has a degree of unsaturation of, for example, 0.8 to 2.2, or preferably 1.0 to 2.0 and has a Mooney viscosity (ML 1+8, at 125° C.) of, for example, 25 to 90, or preferably 30 to 60.

The mixing ratio of the pressure-sensitive adhesive resin with respect to 100 parts by mass of the pressure-sensitive adhesive composition is, for example, 5 to 70 parts by mass, or preferably 10 to 50 parts by mass.

Examples of the metal which has a higher ionization tendency than that of the metal adherend include zinc, aluminum, magnesium, or calcium when the metal adherend is, for example, a cold rolled steel plate, a hot rolled steel plate, a zinc-plated steel plate, an aluminum zinc-plated steel plate, an aluminum-plated steel plate, a stainless steel plate, or the like.

Examples of the metal which has a higher ionization tendency than that of the metal adherend include iron, zinc, aluminum, magnesium, or calcium when the metal adherend is, for example, a nickel zinc-plated steel plate or the like and examples thereof include nickel, iron, zinc, aluminum, magnesium, or calcium when the metal adherend is, for example, a tin plate or the like.

Examples of the metal which has a higher ionization tendency than that of the metal adherend include tin, nickel, iron, zinc, aluminum, magnesium, or calcium when the metal adherend is, for example, a lead tin-plated steel plate (a terne-plated steel plate) or the like and examples thereof include lead, tin, nickel, iron, zinc, aluminum, magnesium, or calcium when the metal adherend is, for example, a copper-plated steel plate or the like.

These metals can be used alone or in combination.

Of the metals, in view of stability and safety, preferably, zinc is used.

The average particle size of the metal is not particularly limited and is, for example, 10 μm to 1000 μm, preferably 20 μm to 500 μm, or more preferably 30 μm, to 250 μm.

The mixing ratio of the metal with respect to 100 parts by mass of the pressure-sensitive adhesive resin is, for example, 5 to 100 parts by mass, preferably 10 to 80 parts by mass, or more preferably 15 to 50 parts by mass.

The pressure-sensitive adhesive composition contains the electrically-conductive carbon. By allowing the electrically-conductive carbon to be contained, even when the metal adherend does not come into contact with the metal which has a higher ionization tendency than that of the metal adherend, the metal adherend can be electrically conducted to the metal via the electrically-conductive carbon. Therefore, the used amount of the metal which has a higher ionization tendency than that of the metal adherend can be reduced, so that the weight reduction of the vibration-damping sheet can be achieved.

The electrically-conductive carbon is not particularly limited and examples thereof include acetylene black, ketjen black, furnace black, channel black, thermal black, and carbon nanotube.

These electrically-conductive carbons can be used alone or in combination.

Of the electrically-conductive carbons, in view of electrically-conductive characteristics, preferably, acetylene black is used.

The mixing ratio of the electrically-conductive carbon with respect to 100 parts by mass of the pressure-sensitive adhesive resin is, for example, 5 to 100 parts by mass, preferably 10 to 80 parts by mass, or more preferably 40 to 60 parts by mass.

Furthermore, in addition to the above-described component, a softener and tackifier, and moreover, if necessary, a known additive such as a cross-linking agent, a cross-linking accelerator, a filler, a foaming agent, a lubricant, an oxidation inhibitor, a thixotropic agent (for example, montmorillonite or the like), oils (for example, animal oil, vegetable oil, mineral oil, or the like), a pigment, an antiscorching agent, a stabilizer, a plasticizer, an ultraviolet absorber, an antifungal agent, or a fire retardant can be added to the pressure-sensitive adhesive composition at an appropriate proportion.

Examples of the softener include a paraffin-based oil; a naphthene-based oil; a liquid rubber such as a liquid isoprene rubber, a liquid butadiene rubber, and polybutene; and esters such as phthalate ester and phosphate ester.

These softeners can be used alone or in combination.

Of the softeners, preferably, polybutene is used.

The kinetic viscosity at 40° C. of the polybutene is, for example, 10 to 200000 mm²/s, or preferably 1000 to 100000 mm²/s and the kinetic viscosity at 100° C. thereof is, for example, 2.0 to 4000 mm²/s, or preferably 50 to 2000 mm²/s.

The mixing ratio of the softener with respect to 100 parts by mass of the pressure-sensitive adhesive resin is, for example, 10 to 150 parts by mass, or preferably 30 to 120 parts by mass.

The tackifier is not particularly limited and examples thereof include a rosin resin, a terpene resin (for example, a terpene-aromatic liquid resin and the like), a coumarone-indene resin, a phenol resin, a phenol-formalin resin, a xylene-formalin resin, and a petroleum resin (for example, a C5 petroleum resin, a C9 petroleum resin, a C5/C9 petroleum resin, and the like).

These tackifiers can be used alone or in combination.

Of the tackifiers, preferably, a petroleum resin is used.

The mixing ratio of the tackifier with respect to 100 parts by mass of the pressure-sensitive adhesive resin is, for example, 5 to 150 parts by mass, or preferably 10 to 100 parts by mass.

By adding the softener and the tackifier to the pressure-sensitive adhesive composition at an appropriate proportion, the glass transition temperature (Tg) of the pressure-sensitive adhesive composition can be adjusted.

The above-described components are blended at the above-described mixing proportion and are kneaded with, though not particularly limited, for example, a mixing roll, a pressure kneader, an extruder, or the like, so that the pressure-sensitive adhesive composition is prepared as a kneaded product.

Thereafter, the obtained kneaded product is extended by applying pressure by, for example, a calendering, an extrusion molding, a press molding, or the like, so that the resin layer is laminated on the surface of a releasing paper or the like. In this way, the resin layer can be formed.

The thickness of the resin layer is, for example, 0.5 to 6 mm, or preferably 0.5 to 3 mm

Preferably, the volume resistivity of the resin layer is low. The volume resistivity of the resin layer is, for example, 1×10⁸Ω cm or less, preferably 5×10⁷Ω cm or less, or more preferably 1×10⁷Ω cm or less. The volume resistivity can be measured in conformity with a method described in ASTM D991.

The glass transition temperature (Tg) of the resin layer is, for example, −40° C. or more and 20° C. or less, preferably −35° C. or more and 15° C. or less, or more preferably −30° C. or more and 10° C. or less.

The glass transition temperature (Tg) is measured at a measuring frequency of 1 Hz from a peak of temperature of loss elastic modulus G″ in a dynamic viscoelasticity measurement.

When the glass transition temperature (Tg) of the resin layer is within a range of −40° C. or more and 20° C. or less, the resin layer develops particularly excellent vibration-damping characteristics.

Next, the constraining layer is bonded to the surface that is the opposite side with respect to the laminated side of the releasing paper in the resin layer, so that the vibration-damping sheet is obtained.

The constraining layer constrains the resin layer and attempts to improve the strength of the resin layer by imparting toughness thereto. The constraining layer is in a sheet shape, light in weight, and a thin film. Preferably, the constraining layer is formed from a material that allows close contact and integration with the resin layer. The material is not particularly limited and examples thereof include a glass cloth, a resin impregnated glass cloth, a synthetic resin non-woven fabric, a carbon fiber, and a polyester film.

The glass cloth is cloth formed from a glass fiber and a known glass cloth is used.

The resin impregnated glass cloth is obtained by performing an impregnation treatment of a synthetic resin such as a thermosetting resin and a thermoplastic resin into the above-described glass cloth and a known resin impregnated glass cloth is used. The thermosetting resin is not particularly limited and examples thereof include an epoxy resin, a urethane resin, a melamine resin, and a phenol resin. Also, the thermoplastic resin is not particularly limited and examples thereof include a vinyl acetate resin, an ethylene-vinyl acetate copolymer (EVA), a vinyl chloride resin, and an EVA-vinyl chloride resin copolymer.

The above-described thermosetting resins and thermoplastic resins can be used alone or in combination, respectively.

The synthetic resin non-woven fabric is not particularly limited and examples thereof include a polypropylene resin non-woven fabric, a polyethylene resin non-woven fabric, and an ester-based resin non-woven fabric.

The carbon fiber is cloth made of a fiber mainly composed of carbon and a known carbon fiber is used.

The polyester film is not particularly limited and examples thereof include a polyethylene terephthalate (PET) film, a polyethylene naphthalate (PEN) film, and a polybutylene terephthalate (PBT) film. Preferably, a PET film is used.

Of the constraining layers, in view of adhesiveness, strength, and cost, preferably, a glass cloth and a resin impregnated glass cloth are used.

The thickness of the constraining layer is, for example, 0.05 to 2.0 mm, or preferably 0.1 to 1.0 mm.

The total thickness of the resin layer and the constraining layer is substantially set to be in the range of, for example, 0.55 to 8.0 mm.

The resin layer and the constraining layer can be bonded to each other by, for example, compression bonding, thermal compression bonding, or the like.

The vibration-damping sheet obtained in this manner is bonded to the metal adherend to achieve vibration damping of the metal adherend. An example of the metal adherend includes a steel plate used in various industrial machines including transportation machines.

The steel plate is not particularly limited and examples thereof include a cold rolled steel plate, a hot rolled steel plate, a zinc-plated steel plate, a tin plate, a lead tin-plated steel plate (a terne-plated steel plate), a copper-plated steel plate, an aluminum-plated steel plate, a nickel zinc-plated steel plate, an aluminum zinc-plated steel plate, and a stainless steel plate.

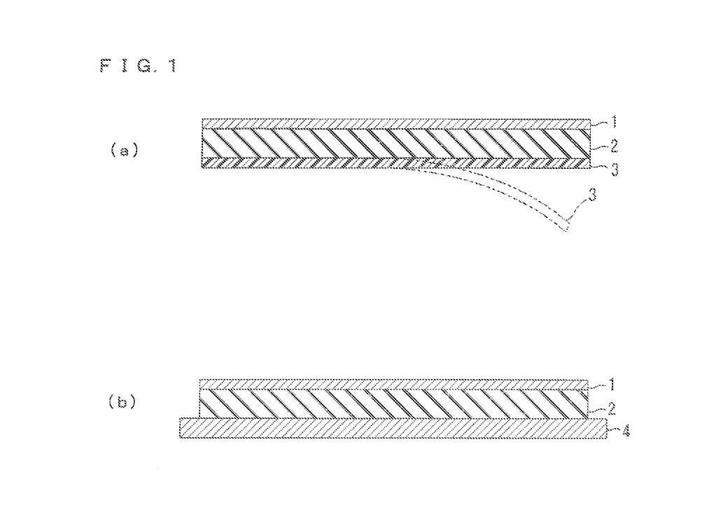

To be more specific, in the vibration-damping sheet, as shown in FIG. 1 (a), a resin layer 2 is laminated on a constraining layer 1 and a releasing paper 3 is bonded to the surface of the resin layer 2 as required. At the time of its use, as shown by a phantom line, the releasing paper 3 is peeled from the surface of the resin layer 2 and as shown in FIG. 1 (b), the surface of the resin layer 2 is bonded to a steel plate 4 as the metal adherend, so that vibration-damping sheet can achieve vibration damping of the steel plate 4 as the metal adherend.

The resin layer 2 and the steel plate 4 can be bonded to each other by, though not particularly limited, for example, compression bonding, thermal bonding, or the like.

When the vibration-damping sheet of the present invention is bonded to the automobile steel plate or the like, the steel plate is subjected to an electrodeposition coating after the vibration-damping sheet is bonded thereto. Therefore, a portion of the steel plate to which the vibration-damping sheet is bonded is not subjected to a coating. However, even when water or oxygen infiltrates a bonded portion of the vibration-damping sheet in the steel plate, in the bonded portion, the metal adherend is not easily oxidized while the metal contained in the resin layer is oxidized for sacrificial protection due to the function of a local cell. That is, the metal which has a higher ionization tendency than that of the steel plate contained in the resin layer is sacrificially oxidized before the oxidation of the steel plate and emits electrons. On the other hand, the emitted electrons are supplied to the steel plate, so that it is possible to prevent emission of electrons from the steel plate and to reduce the oxidation of the steel plate.

Accordingly, vibration damping of the steel plate as the metal adherend can be achieved and the oxidation of the steel plate is sufficiently reduced, so that the occurrence of corrosion such as rust can be reduced.

### EXAMPLES

The present invention will now be described in more detail by way of Examples and Comparative Example. However, the present invention is not limited to the following Examples and Comparative Example.

### Examples and Comparative Example

Kneaded products (pressure-sensitive adhesive compositions) were prepared in accordance with the mixing formulation shown in Table 1 by blending the components and kneading the mixture with a mixing roll.

Next, each of the obtained kneaded products was extended by applying pressure into a sheet shape by a press molding to be laminated on the surface of a releasing paper, so that a resin layer having a thickness of 2.0 mm was formed.

Thereafter, a constraining layer made of a glass cloth having a thickness of 0.2 mm was bonded to the surface that is the opposite side with respect to the laminated side of the releasing paper in the resin layer by heat pressing and the total thickness of the resin layer and the constraining layer was adjusted to be 2.2 mm, so that a vibration-damping sheet was fabricated.

(Evaluation)

The glass transition temperature (Tg), the volume resistivity, the vibration-damping characteristics, and a rust test of the obtained vibration-damping sheets in Examples and Comparative Example were measured/conducted as follows.

(1) Glass Transition Temperature (Tg)

In Examples and Comparative Example, the glass transition temperature (Tg) of the resin layers in the vibration-damping sheets was measured at a measuring frequency of 1 Hz from a peak of temperature of loss elastic modulus G″ in a dynamic viscoelasticity measurement. The results are shown in Table 1.

(2) Volume Resistivity

In Examples and Comparative Example, the volume resistivity of the resin layers in the vibration-damping sheets was measured by a measuring method in conformity with ASTM D991. The results are shown in Table 1.

(3) Vibration-Damping Characteristics (Loss Factor)

In Examples and Comparative Example, the loss factor associated with the second resonance point at 20° C. of the vibration-damping sheets was measured by a center excitation method. The loss factor of 0.05 or more is defined as a criterion of excellent vibration-damping characteristics. The results are shown in Table 1.

(4) Rust Test

0.05 mL of 5 mass % salt water was added dropwise to a cold rolled steel plate (SPCC-SD, manufactured by Nippon Testpanel Co., Ltd.) having a width of 100 mm×a length of 100 mm×a thickness of 0.8 mm Then, each of the vibration-damping sheets cut out into a width of 50 mm×a length of 50 mm in Examples and Comparative Example was bonded onto the steel plate to be then allowed to stand for 5 hours. Thereafter, the resulting product was heated at 180° C. for 20 minutes, so that the resin layer was thermal bonded and a test piece was obtained.

The vibration-damping sheet of Examples and Comparative Example was peeled from each of the test pieces one day after the thermal bonding of the resin layer and the state of the steel plate was observed. The results are shown in Table 1.

TABLE 1

| | | | Ex. Comp. Ex. | | |
|---|---|---|---|---|---|
| | | | Ex. 1 | Ex. 2 | Comp. Ex. |
| Mixing Formulation of | Rubber | Butyl Rubber | 100 | 100 | 100 |
| Pressure-Sensitive | Metal (Zinc) | Average Particle | 10 | 15 | — |
| Adhesive Composition | | Size 100 μm | | | |
| (Resin Layer) | Electrically-Conductive | Acetylene Black | 30 | 50 | — |
| | Carbon | | | | |
| | Softener | Polybutene | 50 | 50 | 50 |
| | Filler | Carbon Black | — | — | 3 |
| | | CaCO₃ | — | — | 50 |
| | Tackifier | Petroleum Resin | 75 | 75 | 75 |
| Evaluation | Glass Transition Temperature (° C.) | | −25 | −25 | −25 |
| | Volume Resistivity (Ωcm) | | 4 × 10⁶ | 5 × 10⁴ | 1 × 10¹³ |
| | Vibration-Damping | 20° C. Loss Factor | 0.15 | 0.16 | 0.15 |
| | Characteristics | | | | |
| | Rust Test | State in Bonded | Slightly Grayish | Slightly Grayish | Entirely Black, |
| | | Portion | White | White | Dark Brown |

Abbreviations of the components in Table 1 are shown in the following.

Butyl rubber: JSR Butyl 268, a degree of unsaturation of 1.6, a Mooney viscosity of 51 (ML 1+8, at 125° C.), manufactured by JSR Corporation

Acetylene black: DENKA BLACK particle-shaped product, manufactured by DENKI KAGAKU KOGYO KABUSHIKI KAISHA

Polybutene: Polybutene HV 300, a kinetic viscosity of 26000 mm²/s (at 40° C.), a kinetic viscosity of 590 mm²/s (at 100° C.), manufactured by NIPPON OIL CORPORATION

Carbon Black: Asahi #50, insulating carbon black, manufactured by ASAHI CARBON CO., LTD.

CaCO₃: calcium carbonate, manufactured by MARUO CALCIUM CO., LTD.

Petroleum resin: Escorez 1202U, manufactured by Exxon Mobile Corporation

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICABILITY

The vibration-damping sheet of the present invention can be used in a method for damping vibration in which vibration damping of a steel plate or the like is achieved by bonding the vibration-damping sheet to the steel plate or the like of various industrial products.

1. A vibration-damping sheet to be bonded to a metal adherend comprising:
a resin layer and
a constraining layer laminated on the resin layer, wherein
the resin layer contains a pressure-sensitive adhesive resin, a metal which has a higher ionization tendency than that of the metal adherend, and an electrically-conductive carbon.

2. The vibration-damping sheet according to claim 1, wherein
the volume resistivity of the resin layer is 1×10⁸Ω cm or less.

3. The vibration-damping sheet according to claim 1, wherein
the metal is zinc.

4. The vibration-damping sheet according to claim 1, wherein
the glass transition temperature (Tg) of the resin layer is −40° C. or more and 20° C. or less.

5. The vibration-damping sheet according to claim 1, wherein
the constraining layer is made of a glass cloth.

6. A method for damping vibration comprising:
bonding a vibration-damping sheet to a metal adherend, wherein
the vibration-damping sheet comprises:
a resin layer and
a constraining layer laminated on the resin layer, and
the resin layer contains a pressure-sensitive adhesive resin, a metal which has a higher ionization tendency than that of the metal adherend, and an electrically-conductive carbon.

7. A method for damping vibration comprising:
bonding a vibration-damping sheet to a steel plate or a zinc-plated steel plate, wherein
the vibration-damping sheet comprises:
a resin layer and
a constraining layer laminated on the resin layer, and
the resin layer contains a pressure-sensitive adhesive resin, zinc, and an electrically-conductive carbon.
